(19) United States
(12) Patent Application Publication
(10) Pub. No.: US 2004/0136346 A1
(43) Pub. Date: Jul. 15, 2004

(54) Computer telephony integration

(76) Inventor: Laurence J Booton, Woodbridge (GB)

Correspondence Address: Nixon & Vanderhye, 8th Floor, 1100 North Glebe Road, Arlington, VA, 22201-4714, US

(21) Appl. No.: 10/471,410

(22) PCT Filed: Mar. 21, 2002
(86) PCT No.: PCT/GB02/01299

(30) Foreign Application Priority Data
Mar. 29, 2001 (EP) 01302933.5

(51) Int. Cl. H04Q 7/24

(52) U.S. Cl. 370/338

(57) ABSTRACT

A CTI system comprising a switch and a CTI controller therefor, a plurality of telephones connected to the switch, and a telephony card connected to the switch. When an incoming call is received for a user who has specified multiple telephone alerting, including a remote telephone, the CTI controller commands the switch to route the call to the card, generates a second call ID which is different from the first call ID already allocated by the switch for the incoming call, commands the card to make an outgoing call, associated with that second call ID, via the switch to the remote telephone, and to join the calls when the outgoing call is answered. The card will now be able to monitor the network signalling and report to the CTI controller when the remote telephone clears down. The association of a different call ID with the outgoing leg from the telephony card prevents an Automatic Route Optimisation function of the switch from clearing down the legs to and from the telephony card and joining the incoming and outgoing calls via its internal switching mechanism, which would result in the consequent loss of monitoring ability for the telephony status of that call.

This invention relates to the use of a computer for controlling the operation of a telephony system, such use is known in the art as computer telephony integration, known by the initials CTI, and the systems employing such control are known as CTI systems.

As a general background, the reader will find examples of such CTI systems disclosed in the articles “Introduction to Computer Telephony Integration”, by A. Catchpole, G. Crook, and D. Chesterman, British Telecommunications Engineering, Vol. 14, July 1995; “Computer Telephony Integration—The Meridian Norstar”, by A. Catchpole, British Telecommunications Engineering, Vol. 14, October 1995; “Computer Telephony Integration—The Meridian 1 PBX”, by P. Johnson, A. Catchpole, and L. Booton, British Telecommunications Engineering, Vol. 15, July 1996; “Callscape Computer Telephony Integration for the Small Business”, by G. Hillson, G. Hardcastle, and M. Allington, British Telecommunications Engineering, Vol. 15, Jan. 1997, and “Call Centres—Doing Business by Telephone” by M. Bonner, British Telecommunications Engineering, Vol. 13, July 1994.

Furthermore, a method is known of operating a CTI system comprising a CTI-enabled PBX, an associated CTI controller, and a plurality of user workstations, each workstation comprising a computer connected to the CTI controller and a telephone connected to the PBX In this method, the CTI controller stores respective user-associated profiles, each including a user-associated workgroup containing names of users of the system, in whose telephony status the user associated with that workgroup is interested, and the PBX on receipt of an incoming call retrieves from the signalling data a dialled number (known as the Dialled Number Identification Service number (DNIS)) and the calling line identity or identification (CLI), and passes these to the CTI controller. The CTI controller translates the DNIS to a username for the called user and accesses the workgroups to find out which contain that username. The CTI controller then sends a message containing that username to each computer at which a user, whose workgroup contains that username, is currently logged on to the CTI controller. It will be appreciated that in the art, the terms log on, logon, log in and login are synonymous and interchangeable, as are the terms log off, logoff, log out and logout.

While a user is currently logged on to the CTI controller, his computer displays a respective set of icons representing the members of that user's workgroup, the icons being in the form of respective facial images, each icon including a text display, e.g. “Free”, to indicate the current telephony status of the corresponding user, and upon receipt of this message, the computers change the text display of the icon corresponding to the received username to “Ringing”. A user can answer an incoming call for a member of his workgroup by sending an answer message from his computer to the CTI controller, and the CTI controller responds by commanding the PBX to connect the incoming call to that user's telephone. This method is referred to as Distributed Office Telephony (DOT).

According to a first aspect of the present invention, there is provided a computer telephony integration, referred to hereafter as CTI, system comprising a switch and a CTI controller therefor, and a plurality of network terminals connected to the switch, the switch being arranged to respond to an incoming call by generating a call identity, referred to hereafter as the switch-generated call identity, and associating it with the incoming call; and to send to the CTI controller signalling information of the incoming call and the associated switch-generated call identity, the system being characterised by a communications card connected to the switch via first and second communications links; and further characterised in that the CTI controller is arranged:

to respond to receipt of the signalling information from the switch;

by determining a destination network terminal for that incoming call, and, in the event that the determined destination network terminal is a remote network terminal,

by sending a command to the switch to route the incoming call via the first communications link to the communications card,

by generating, having regard to said associated switch-generated call identity received from the switch, a call identity, referred to hereafter as the controller-generated call identity, different from said associated switch-generated call identity,

by sending a command, including the network number of that remote network terminal, to the communications card to originate an outgoing call to that remote network terminal by sending communications signalling to the switch via the second communications link,

by sending a command to the switch to associate said controller-generated call identity with said outgoing call, and

by sending, in response to receipt of notification from the switch that said outgoing call has been answered, a command to the communications card to join thereat the incoming call and the outgoing call.

Preferably, the CTI controller is arranged to determine the destination network terminal for that incoming call by determining the identity of the called user from the signalling information received from the switch and by accessing a store of called users' alerting requirements in accordance with that determined called user identity.

Preferably, the network terminals are telephones, and the communications card is a telephony card.

Each of the plurality of network terminals connected to the switch may be associated with a respective computer connected to the CTI controller to form a respective workstation.

According to a second aspect of the present invention, there is provided a method of operating a computer telephony integration, referred to hereafter as CTI, system comprising a switch and a CTI controller therefor, and a plurality of network terminals connected to the switch, the method comprising the steps:

receiving at the switch an incoming call;

generating by the switch a first call identity and associating it with the incoming call;

sending to the controller signalling information of the incoming call together with said associated first call identity; and

at the controller,

determining for that incoming call a destination network terminal, and, in the event that the determined destination network terminal is a remote network terminal,

sending a command to the switch to route the incoming call via a first communications link to a communications card,

generating, having regard to said associated switch-generated call identity received from the switch, a call identity, referred to hereafter as the controller-generated call identity, different from said associated switch-generated call identity,

sending a command, including the network number of that remote network terminal, to the communications card to send communications signalling to the switch via a second communications link to make an outgoing call to that remote network terminal,

sending a command to the switch to associate said controller-generated call identity with said outgoing call, and

upon receipt of notification from the switch that said outgoing call has been answered, sending a command to the communications card to join thereat the incoming call and the outgoing call.

Preferably, the determining of the destination network terminal comprises retrieving from said signalling information received from the switch the identity of the called user, and accessing a store of called users' alerting requirements in accordance with that determined called user identity.

Preferably, the network terminals are telephones and the communications card is a telephony card, and the incoming and outgoing calls are telephony calls.

By deliberately using a call identity for the outgoing call from the communications card to the remote network terminal via the switch which is different from the call identity that the switch allocates to the incoming call, it will be impossible for the switch to operate an automatic route optimisation function aimed at removing “tromboned” legs of a completed call which extend from the switch to and from the communications card. This enables the CTI controller (server) to be notified by the external network signalling messages or signals of the ending of that call and its cleardown.

Preferred embodiments of apparatus and methods of the present invention will now be described by way of example with reference to the drawings, in which:—

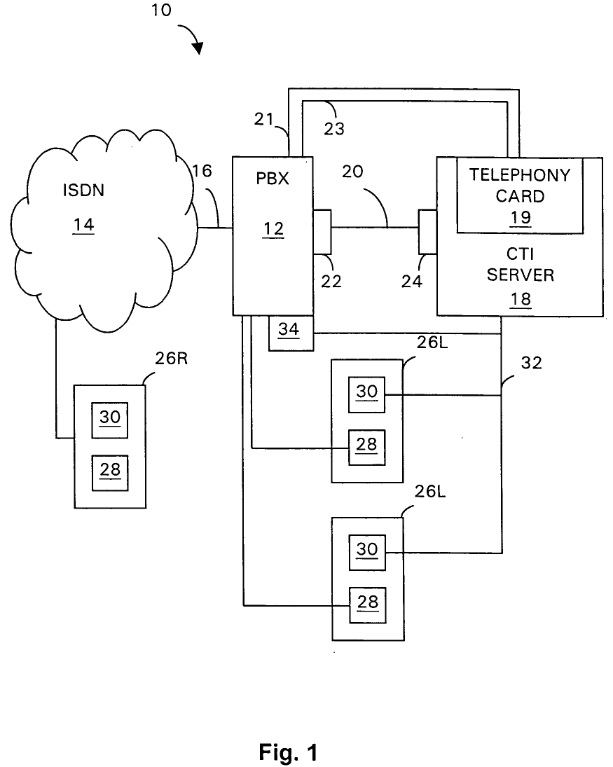

FIG. 1 is a block diagram of an apparatus of the present invention;

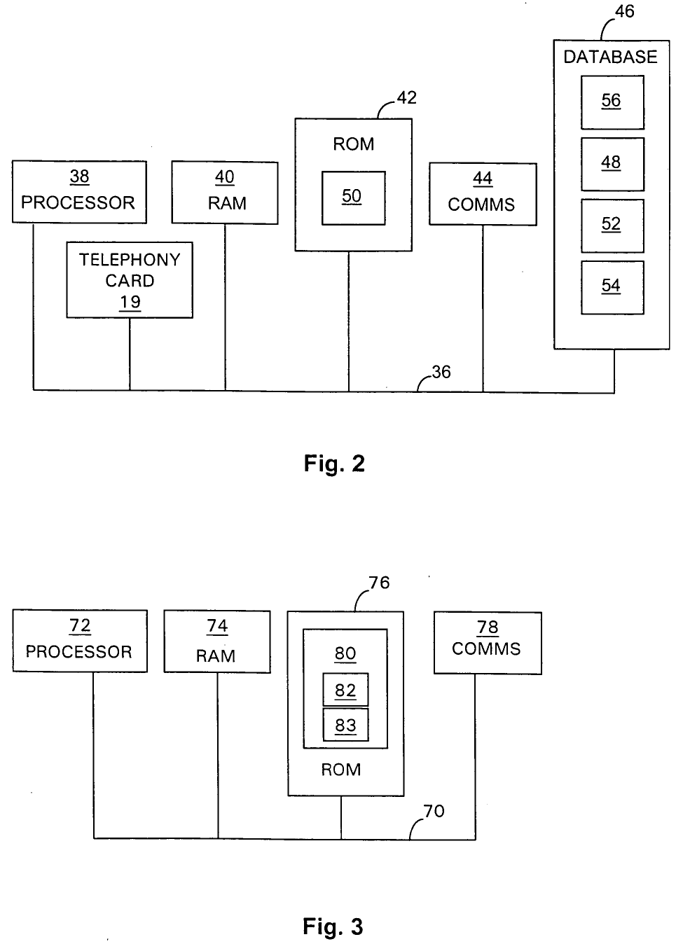

FIG. 2 shows the component parts of a CTI server of the apparatus of FIG. 1;

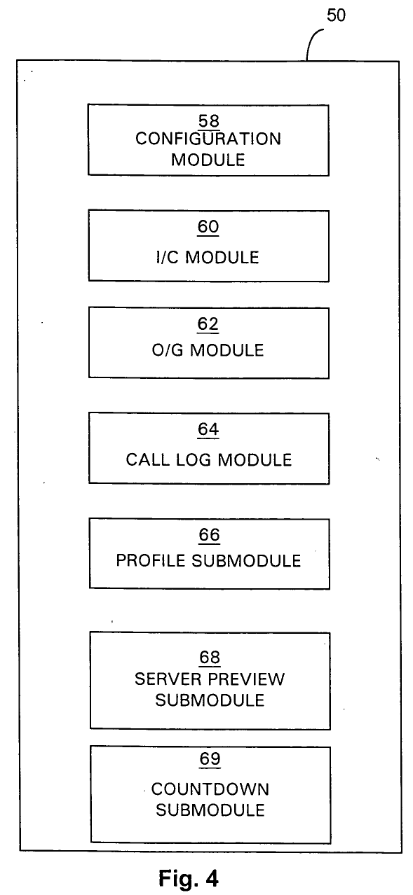

FIG. 3 shows the component parts of a CTI client of the apparatus of FIG. 1;

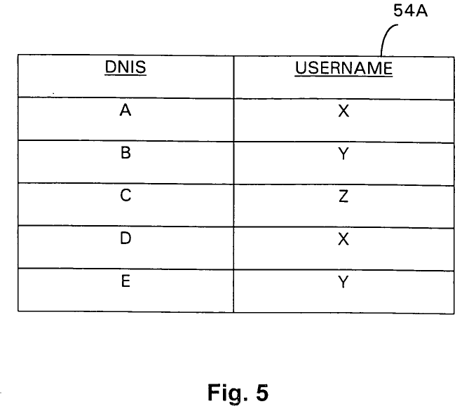

FIG. 4 shows the modules of a CTI program which controls the operation of the CTI server;

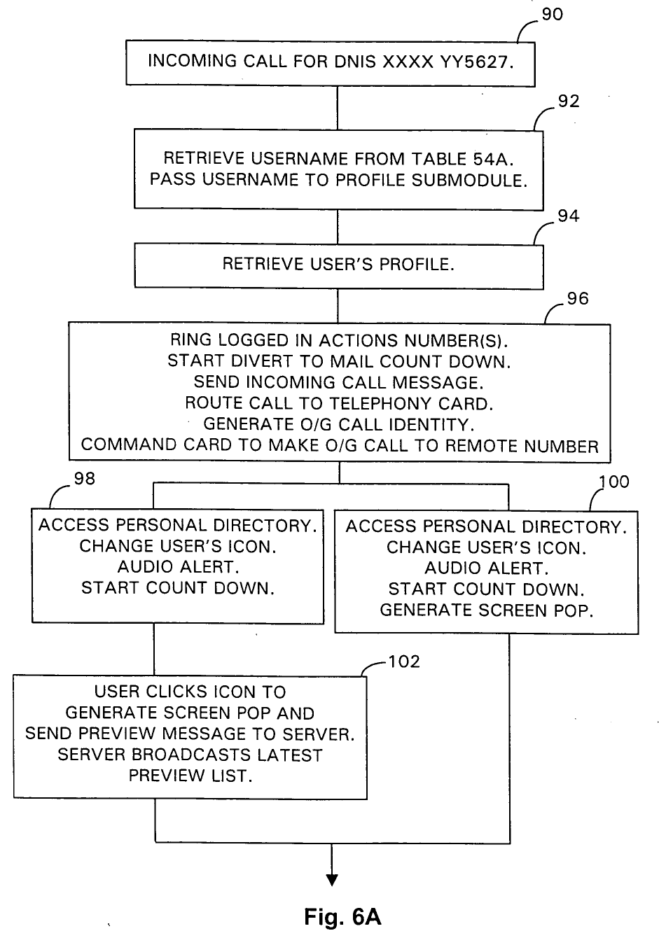

FIG. 5 shows the structure of part of a number-to-name table used by the CTI server; and

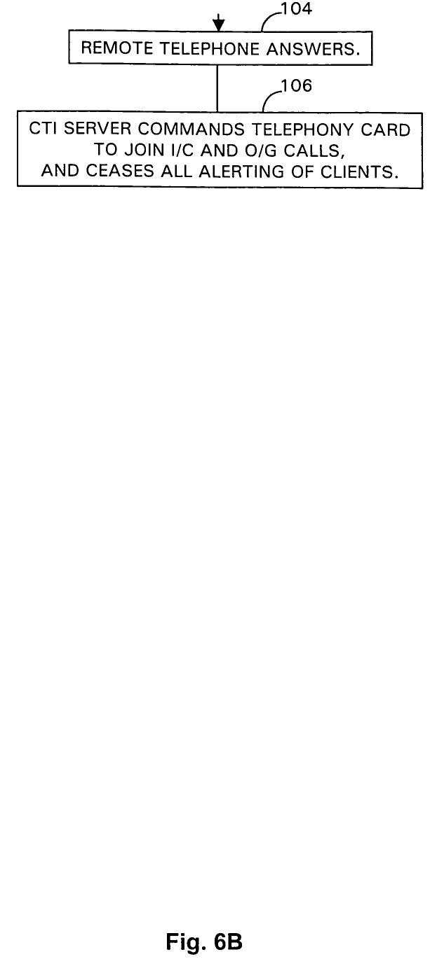

FIGS. 6A and 6B are a flow chart showing steps of a method of the present invention.

In this description the following acronyms are used

ARO—Automatic Route Optimisation,

CLI—Calling Line Indication, also known as Calling Line Identity,

CSTA—Computer Supported Telecommunications Applications,

CTI—Computer Telephony Integration,

DNIS—Dialled Number Identification Service number,

DOT—Distributed Office Telephony,

ISDN—Integrated Services Digital Network,

LAN—Local Area Network,

PBX—Private Branch Exchange,

RAM—Random Access Memory,

ROM—Read Only Memory,

In FIG. 1 there is shown a CTI system 10, also referred to as a DOT system, comprising a CTI-enabled PBX 12, constituting a switch of the present invention, connected to an ISDN 14 via an ISDN primary rate link 16, a CTI server 18, also referred to as a CTI controller, connected to the PBX 12 via a data link 20, and telephony card 19, constituting a communications card of the present invention, connected to the PBX 12 via multiplexed communication links 21 and 23 to respective sets of extension numbers. The links 21 and 23 have respective multiplexer/demultiplexers (not shown) at each end, in known manner.

The PBX 12 has a CTI interface 22 which operates in accordance with the CTI protocol known as Computer Supported Telecommunications Applications (CSTA), and the CTI server 18 has a CTI interface 24 which operates in accordance with that protocol. There are a number of proprietary CTI protocols, e.g. Meridian Link from Nortel Networks, and several “open”, or proposed standard, CTI protocols, including CSTA, but the performance of the present invention is not dependent upon the use of any particular CTI protocol.

The CTI system 10 also comprises a plurality of work desks, also known as workstations, 26R, situated remotely from the PBX 12, and a plurality of work desks 26L, situated locally to the PBX 12, each work desk having a respective telephone terminal 28R, 28L, referred to hereinafter as a telephone and constituting a network terminal of the present invention, and a respective computer terminal 30R, 30L, referred to hereinafter as a CTI client, or just client. For convenience, only one remote work desk 26R and only two local work desks 26L are shown.

The CTI server 18 and the local CTI clients 30L are directly connected to a LAN 32, and each remote CTI client 30R is indirectly connected to the LAN 32 via the ISDN 14 when a user at the respective remote work desk 26R makes a call to a predetermined destination number for access to the LAN 32. The PBX 12 receives that call and connects it to a corresponding port which is connected to the LAN 32 via an ISDN/LAN bridge 34. In a variant, the ISDN/LAN bridge 34 is connected directly to the ISDN 14.

The telephony card 19 is a telephony card from Dialogic Corporation. It is housed integrally with the CTI server 18 and has a data link (see FIG. 2) to the CTI server 18 for receiving commands and sending signalling information.

Before the description of the preferred embodiment proceeds further, it will be instructive to describe the conventional operation of the combination of a switch, not being a CTI-enabled switch, and a telephony card.

In this conventional operation, when a call, referred to herein as the incoming call, is received by the switch it is allocated a call ID and routed via a first communications link to the telephony card. The signalling information (CLI, DNIS and call ID) is retrieved by a controlling program at the telephony card and used to determine the future handling of the call. If the decision is to route the call to a remote telephone, i.e. a telephone not connected to the switch, the telephony card sends telephony signalling information via a second communications link to the switch, that signalling information including the number of that remote telephone, i.e. the “dialled number”, and the received call ID, and the switch makes a call, referred to herein as the outgoing call, via the public telephone network, e.g. the ISDN 14, to the remote number. When the call to that remote telephone is answered, the switch forwards sends call progress messages received from the ISDN 14 to the telephony card, and the telephony card joins the first communications link to the second communications link. The part of the overall call from the switch to the telephony card over the first communications link is referred to as the first leg, and the corresponding part over the second communications link is referred to as the second leg.

The call is now referred to as being “tromboned”, i.e. it goes to the telephony card via the first leg and returns via the second leg. The PBX 12 control program has a function known as Automatic Route Optimisation (ARO), and this operates to monitor telephony conditions on legs of calls between the switch and the telephony card. If the ARO function detects that two legs are associated with the same call ID, it joins the original incoming call to that outgoing call using its internal switching mechanism, and releases those legs to the telephony card.

Proceeding now with the description of the preferred embodiment of the present invention, in FIG. 2, the CTI server 18 comprises an internal bus 36 to which is connected a processor 38, a RAM 40, a ROM 42, a data communications stack 44, and a database 46. The ROM 42 contains a conventional operating system program for controlling the processor 38, and a CTI program 50 for performing DOT functions including managing user profiles 52, and tables 54, and for controlling the telephony card 19. The database 46 stores call logs 56, the user profiles 52, the tables 54, and user-associated stores 48.

The telephony card 19 is connected to the bus 36 of the CTI server 18 for receiving commands from the CTI program 50 and for sending signalling messages to the CTI program 50.

Each user profile 52 includes a Logged In Actions section and a Logged Out Actions section, and each of these sections contains a pointer to a respective alerting substore 48A of the store 48 associated with that user profile 52. The alerting substores 48A contain the numbers of the extensions and remote telephones that the associated user requires to be alerted for an incoming call for when he is logged in or logged out. These can be his current workstation telephone (he can log in at any of the workstations, known as “hotdesking”), his home telephone and his mobile telephone, and any others that he might add to the alerting substore 48A on a temporary or permanent basis.

As shown in FIG. 3, the CTI client 30L comprises an internal bus 70 to which is connected a processor 72, a RAM 74, a ROM 76, and a data communications stack 78. The ROM 76 contains an operating system program for controlling the processor 72, and also contains a CTI program 80, including a Client Preview module 82 and a Client Countdown module 83, for the operation of the CTI client 30L.

As shown in FIG. 4, the CTI program 50 comprises a number of main modules, namely: a Configuration module 58 for enabling a user to configure his profile; an Incoming Call module 60, including a Server Preview submodule 68 and a Server Countdown submodule 69; an Outgoing Call module 62; a Call Log module 64; and a Profile submodule 66 for managing the user profiles 52.

When a user launches his DOT client application and logs on to the CTI server 18, the CTI server 18 accesses a workgroup substore 48W of the store 48 associated with that user and instructs the display on that user's client of icons corresponding to the usernames in the workgroup substore 48W. Thus that user's client displays a respective set of icons representing the members of that user's workgroup. The user will have initially entered in his workgroup substore 48W usernames of those “Users in whose calls I am interested”.

It will be appreciated that a user will always include his own username in his workgroup substore 48W to ensure that he always has his own icon displayed as a member of his workgroup, and that he is immediately alerted on receipt at the PBX 12 of a call for him.

The steps of a preferred method of the present invention will now be described with reference to the flow chart of FIGS. 6A and 6B.

At step 90, the PBX 12 receives an incoming call from the ISDN 14, retrieves from the call signalling data a CLI, i.e. the telephone number of the calling terminal, constituting a caller identity, and also a DNIS, i.e. the dialled telephone number, e.g. xxxxx yy5627 and constituting a called user identity, allocates a unique call ID, constituting a first call identity of the present invention, and, as is known in the art, presents the call to an internal controlled directory number (CDN), corresponding to 5627, as a result of which the PBX 12 responds by passing all this data to the CTI server 18 in a Route Request message. In the art, such CDNs are also called routing points.

At step 92, the Incoming Call module 60 of the CTI server 18 uses the received DNIS to access a DNIS-to-username translation table 54A (FIG. 5), retrieve a username associated with the received DNIS, and pass the username to the Profile submodule 66 of the CTI server 18. Some users, e.g. those with usernames X and Y in FIG. 5, might be associated with two or more different DNISs, e.g. one for private calls, and another for business calls.

At step 94, the Profile submodule 66 uses the retrieved username to access the profiles 52 and retrieve a profile associated with the retrieved username. This profile contains the data on how that user wishes the CTI server 18 to handle the user's telephony events. A current status flag associated with Logged In Actions and Logged Out Actions sections determines which of these two is made available to the Server Preview submodule 68 of the CTI server 18. In a variant, the CTI server 18 manages a list of logged in users, which the Profile submodule 66 consults to ascertain which of the two Actions sections is to be used.

At step 96, assuming that the user is logged in, the Server Preview submodule 68 refers to the user's Logged In Actions section of the retrieved profile, and, consequently, that called user's substore 48A, to ascertain which telephones to alert. Suppose that the called user has requested that both the workstation at which he is currently logged on (referred to as This Desk) and his home telephone, referred to hereafter as the remote number, are alerted.

The CTI server 18 now proceeds with its alerting operation. It provides a screen alert on the called user's client (step 100 of FIG. 6A), which is in the form of a screen pop containing the name of the caller, callername, (if this is recorded in translation tables 54 in the database 46) and any other details that the called user might have selected to be included, and it also commands the PBX 12 to alert the telephone at that workstation, in response to which the PBX 12 will report the PBX-allocated call ID for that call to the CTI server 18.

The CTI server 18 also provides screen alerts (step 98 of FIG. 6A), by means of the Client Preview module 82, the Server Preview submodule 68, the Client Countdown module 83, and the Server Countdown submodule 69, to any users who have expressed an interest in being notified of the telephony activity of the called user. The operation of these modules and submodules does not form part of the present invention, and will not be described in detail. It will be sufficient for the reader to know that such a user can click on the screen alert (step 102 of FIG. 6A) to preview the incoming call's details, such as the name or CLI of the caller, together with the remaining time before the call is sent to Voicemail, and the usernames of any other such users who are currently previewing that incoming call. A previewing user can elect to answer the call by clicking on an appropriate button.

The CTI server 18, by means of the Outgoing Call module 62, also issues a command (step 96) to the PBX 12 for the incoming call to be routed to the telephony card 19 via a channel in the link 21; it notes the call ID of the incoming call and generates a non-identical call ID (step 96), constituting a second call identity of the present invention, for an outgoing call; and it issues a command (step 96) to the telephony card 19 for an outgoing call to be made to the remote number and for the generated non-identical call ID to be associated with that outgoing call.

At this stage, two telephones are ringing, namely the telephone at the called user's workstation and the remote telephone, and the clients of those users who had expressed an interest in the called user's telephony activity are displaying a screen alert to indicate that a call has been received for the called user. Those other users can preview the call to see who is calling and how much time is left before the CTI server 18 will command the PBX 12 to route the call to Voicemail system (not shown), and can, if they wish, answer the call.

If the CTI server 18 first receives notification that the call is answered by the called user at his workstation, either from the PBX 12 reporting that his telephone had gone offhook or as the result of the called user clicking on his screen alert, then the CTI server 18 will command the PBX 12 to connect the incoming call to the answering user's telephone, and command the PBX 12 to take down the connection to the telephony card 19 through the PBX switching mechanism to the port connected to the link 21. The CTI server 18 will respond correspondingly if that first received notification is in respect of a previewing user electing to answer the call.

If, however, the notification that the CTI server 18 first receives is a call progress message from the ISDN 14 in respect of the remote telephone going offhook (step 104), i.e. the outgoing call is answered at the remote telephone, the CTI server 18 ceases all alerting at the workstations, and commands the telephony card 19 to join the incoming call to the outgoing call (step 106).

As briefly mentioned above, the PBX 12 has, as part of its control program, a function known as Automatic Routing Optimisation (ARO), which monitors the call IDs of legs to and from the telephony card 19. If the ARO function finds that there are two legs having the same call ID, i.e. the two legs are part of one and the same call, it will act to remove that “tromboned” part of that call by joining the incoming and outgoing calls via its own switching mechanism and taking down, i.e. disconnecting, the tromboned legs. Once the PBX 12 has performed such route optimisation, it will not be possible for the CTI server 18 to receive any call progress message in respect of that call. In other words, although the CTI server 18 can, by means of the Call Log module 64, make an entry in the call log 56 in respect of the time at which the call was answered at the remote telephone, it will have no way of knowing when that call was terminated.

It will thus be appreciated that the action of the CTI server 18 in generating a call ID for the outgoing call to be made from the telephony card 19, having regard to the call ID allocated to the incoming call by the PBX 12 such that the two call IDs are not the same, will prevent the ARO function from removing that “tromboned” part of that call. In this way, the telephony card 19 will receive the ISDN-provided call progress message in respect of the clearing down of the call, and report this to the CTI server 18.

The CTI program 50 also performs other DOT functions which are not part of the present invention and will not be described. If the reader is interested, he will find information on these other functions in the above articles and in international patent publications WO98/48557, WO98/48558, WO00/59189, WO00/59190 and WO00/59194.

Whereas the specific embodiments described above are based on a switch in the form of a PBX, it will be appreciated that the present invention embraces other forms of switching function. For example, the switch can be a public network switch, such as a Nortel DMS100 switch which is used in known CTI arrangements in conjunction with a CompuCall CTI controller; and other forms of switching function include switches known as Automatic Call Distributor (ACD), Interactive Voice Response (IVR), and server PBX. Furthermore, the type of switching is not limited to any one form, and, in addition to switched circuit technology, includes Asynchronous Transfer Mode (ATM) switching, and Voice over Internet Protocol (VoIP) switching. With regard to this last form of switching, the switch can be a PBX having an Internet Card, or it can be a general purpose computer, e.g. one running Windows NT, having an Internet card, e.g. a Dialogic Internet card, and in this latter case the CTI controller function is provided by a program running in the computer, rather than in a separate controller. Furthermore, the telephones at the workstations can connect to their respective clients via Internet phone jacks, and in an alternative arrangement telephony can be provided for the user via a sound card in his client.

Thus, it can be seen that in general the present invention can be implemented in any computer controlled switch, by means of a suitable controlling program.

In the above specific embodiments, the called user is an individual person who normally works at a workstation. It will be appreciated that a DNIS need not correspond to an individual person, but may relate to a department or group, or a specific function within a company. Furthermore, more than one DNIS can correspond to such a function. It will also be appreciated that the present invention is applicable to call centre arrangements, where an Automatic Call Distributor determines the destination for the incoming call, and the selected agent has indicated that he wishes to be a teleworking agent and receive calls at, e.g. his home.

Similarly, the present invention includes caller identities other than the abovementioned CLI. These include a cell identity when the caller is using a mobile telephone, an alphanumeric string, an Internet Protocol address, and “null” information, e.g. where a caller has withheld his CLI.

It will also be appreciated that the term CTI, although originating from the computer control of voice telephony, is not limited to voice communications and includes other types of communications, e.g. videotelephony, and multimedia, and the term “call” is to construed accordingly.

Furthermore, whereas the above described specific embodiments are third party CTI arrangements, the skilled person will appreciate that the present invention is also applicable to first party CTI arrangements.

If the remote telephone is connected to a public switched telephone network which uses Signalling System No.7, known as SS7, instead of being connect to the ISDN 14 referred to above, the CTI server 18 will know from receipt of appropriate SS7 supervisory signals that the call to the remote telephone has ended.

In this description, the terms user and workgroup member are used interchangeably and synonymously.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A computer telephony integration, referred to hereafter as CTI, system comprising a switch and a CTI controller therefor, and a plurality of network terminals connected to the switch, the switch being arranged to respond to an incoming call by generating a call identity, referred to hereafter as the switch-generated call identity, and associating it with the incoming call; and to send to the CTI controller signalling information of the incoming call and the associated switch-generated call identity, the system being characterised by a communications card connected to the switch via first and second communications links; and further characterised in that the CTI controller is arranged:
to respond to receipt of the signalling information from the switch;
by determining a destination network terminal for that incoming call, and, in the event that the determined destination network terminal is a remote network terminal,
by sending a command to the switch to route the incoming call via the first communications link to the communications card,
by generating, having regard to said associated switch-generated call identity received from the switch, a call identity, referred to hereafter as the controller-generated call identity, different from said associated switch-generated call identity,
by sending a command, including the network number of that remote network terminal, to the communications card to originate an outgoing call to that remote network terminal by sending communications signalling to the switch via the second communications link,
by sending a command to the switch to associate said controller-generated call identity with said outgoing call, and
by sending, in response to receipt of notification from the switch that said outgoing call has been answered, a command to the communications card to join thereat the incoming call and the outgoing call.

2. A CTI system as claimed in claim 1, wherein the CTI controller is arranged to determine the destination network terminal for that incoming call by determining the identity of the called user from the signalling information received from the switch and by accessing a store of called users' alerting requirements in accordance with that determined called user identity.

3. A CTI system as claimed in either claim 1 or claim 2, wherein said network terminals are telephones, and said communications card is a telephony card.

4. A CTI system as claimed in any one of claims 1 to 3, wherein each of said plurality of network terminals connected to the switch is associated with a respective computer connected to the CTI controller to form a respective workstation.

5. A method of operating a computer telephony integration, referred to hereafter as CTI, system comprising a switch and a CTI controller therefor, and a plurality of network terminals connected to the switch, the method comprising the steps:
receiving at the switch an incoming call;
generating by the switch a first call identity and associating it with the incoming call;
sending to the controller signalling information of the incoming call together with said associated first call identity; and
at the controller,
determining for that incoming call a destination network terminal, and, in the event that the determined destination network terminal is a remote network terminal,
sending a command to the switch to route the incoming call via a first communications link to a communications card,
generating, having regard to said associated switch-generated call identity received from the switch, a call identity, referred to hereafter as the controller-generated call identity, different from said associated switch-generated call identity,
sending a command, including the network number of that remote network terminal, to the communications card to send communications signalling to the switch via a second communications link to make an outgoing call to that remote network terminal,
sending a command to the switch to associate said controller-generated call identity with said outgoing call, and
upon receipt of notification from the switch that said outgoing call has been answered, sending a command to the communications card to join thereat the incoming call and the outgoing call.

6. A method as claimed in claim 5, wherein the determining of the destination network terminal comprises retrieving from said signalling information received from the switch the identity of the called user, and accessing a store of called users' alerting requirements in accordance with that determined called user identity.

7. A method as claimed in either claim 5 or claim 6, wherein said network terminals are telephones and said communications card is a telephony card, and wherein the incoming and outgoing calls are telephony calls.

8. A computer telephony integration system substantially as herein described with reference to the drawings.

9 A method of operating a computer telephony integration system, the method being substantially as herein described with reference to the drawings.
